(19) United States
(12) Patent Application Publication
(10) Pub. No.: US 2014/0210733 A1
(43) Pub. Date: Jul. 31, 2014

(54) PORTABLE COMMUNICATION DEVICE

(71) Applicant: Cho-Yi LIN, New Taipei City (TW)

(72) Inventor: Cho-Yi LIN, New Taipei City (TW)

(21) Appl. No.: 13/831,026

(22) Filed: Mar. 14, 2013

(30) Foreign Application Priority Data
Jan. 30, 2013 (TW) 102103581

(51) Int. Cl. G06F 3/041

(52) U.S. Cl. CPC G06F 3/0416
USPC 345/173

(57) ABSTRACT

A portable communication device is provided. According to one embodiment of the disclosure, the portable communication device includes a first casing comprising a first input unit, and a second casing attached to the first casing. When the second casing is attached to the first casing, a space for the placement of a processing unit can be defined. The second casing further includes a second input unit electrically connected to a processing unit, and the second input unit further includes at least one touch zone. When the at least one touch zone is touched, a sensing signal indicative of the at least one touch zone being touched is delivered to the processing unit. The processing unit controls the portable communication device to operate according to the sensing signal indicating the touched state of the at least one touch zone.

### CROSS-REFERENCE TO RELATED APPLICATIONS

This non-provisional application claims priority under 35 U.S.C. §119(a) on Patent Application No(s). 102103581 filed in Taiwan, R.O.C. on Jan. 30, 2013, the entire contents of which are hereby incorporated by reference.

### BACKGROUND

1. Technical Field

The disclosure relates to a portable communication device, and more particularly to a portable communication device which includes a first input unit and a second input unit and performs a preset operation by determining a sensing signal generated by the second input unit.

2. Related Art

For a portable communication device now, a touch panel facing a user, or buttons (or keys) disposed at the side edge of the casing of the portable communication device are usually employed to control the operation of the portable communication device (e.g. the turning-on and the adjustment of volume). However, another surface of the portable communication device, where an image capturing device is disposed, is not used efficiently.

### SUMMARY

The disclosure relates to a portable communication device, which includes a first casing including a first input unit, and a second casing attached to the first casing. A space for placing a processing unit is defined by the second casing and the first casing. The second casing includes a second input unit electrically connected to the processing unit. The second input unit includes at least one touch zone. When the at least one touch zone is touched, a sensing signal indicating a touched state of the at least one touch zone is transmitted to the processing unit. The processing unit controls a preset operation of the portable communication device according to the touched state of the at least one touch zone.

Moreover, the disclosure relates to an operation method of the foregoing portable communication device. According to an embodiment of the disclosure, the operation method includes the following steps. A sensing signal is received from the second input unit. A touched state of the at least one touch zone corresponding to the sensing signal is determined. According to the touched state of the at least one touch zone, the portable communication device is controlled to perform the preset operation.

### BRIEF DESCRIPTION OF THE DRAWINGS

The disclosure will become more fully understood from the detailed description given herein below for illustration only and thus does not limit the disclosure, wherein:

FIG. 1 is a schematic diagram of a portable communication device according to one embodiment of the disclosure;

FIG. 2A is a schematic diagram of a second casing according to one embodiment of the disclosure;

FIG. 2B is a schematic diagram of a second casing according to another embodiment of the disclosure;

FIG. 3 is a circuit block diagram of a portable communication device according to one embodiment of the disclosure; and

FIG. 4 is a flow chart of a method of controlling the portable communication device according to one embodiment of the disclosure.

### DETAILED DESCRIPTION

In the following detailed description, for purposes of explanation, numerous specific details are set forth in sequence to provide a thorough understanding of the disclosed embodiments. It will be apparent, however, that one or more embodiments may be practiced without these specific details. In other instances, well-known structures and devices are schematically shown in sequence to simplify the drawing.

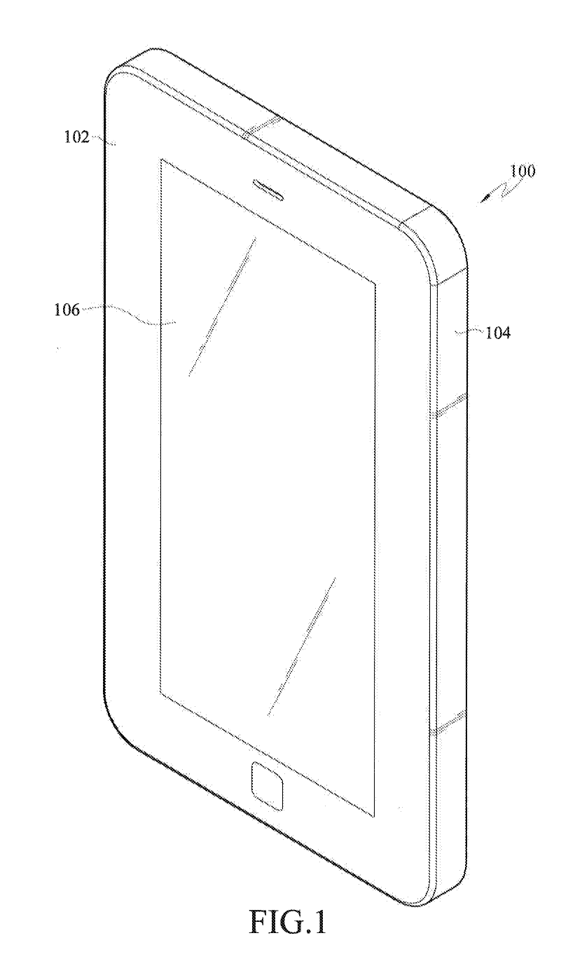

FIG. 1 is a schematic diagram of a portable communication device 100 according to an embodiment of the disclosure. The portable communication device 100 can be, for example, a mobile phone, a tablet computer or an electronic reader. The portable communication device 100 includes a first casing 102 and a second casing 104. A space defined by the first casing 102 and the second casing 104 is used for placing a circuit element or a control circuit (not shown) capable of controlling the operation of the portable communication device 100. The second casing 104 is, for example, a back cover of the portable communication device 100.

The portable communication device 100 further includes a first input unit 106 disposed on or integrated with the first casing 102. The first input unit 106 is used for receiving an input formed by operating the portable communication device 100, and also serves as a display screen.

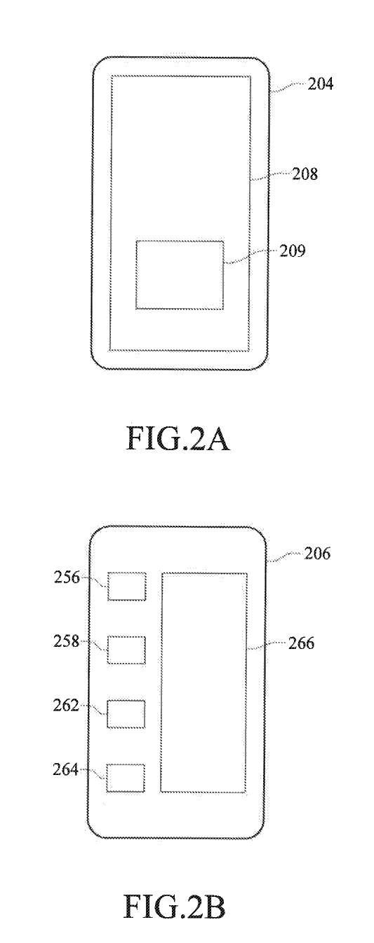

FIG. 2A and FIG. 2B are schematic diagrams of the second casings 204 and 206 according to an embodiment of the disclosure. In the portable communication device, a space defined on the second casing 204 is used for disposing a second input unit 208. The second input unit 208 includes a single touch zone as the same as the first input unit 106 in FIG. 1. The touch zone is used for receiving touch inputs. On the second casing 206, the second input unit includes a plurality of touch zones 256, 258, 262 and 266. The touch zones 256, 258, 262 and 266 respectively receive touch inputs. The second input unit 208 can be, for example, a capacitive touch panel. In this and some embodiments, the second input, unit 208 can include a single touch zone 209.

When one touch zone of the second casing 204 or 206 is touched, a corresponding sensing signal is generated. Specifically, the sensing signal is generated when any one of the touch zones 209, 256, 258, 262 and 266 is touched. The corresponding sensing signal is transmitted to a circuit element (not shown) disposed in a space defined by the first casing and the second casing 204 or 206 in the portable communication device. The circuit element can be, for example, a processing unit. The processing unit processes the received sensing signal to determine whether to perform a corresponding preset operation. Specifically, the preset operation can defined according to a touched area of any one of the touch zones 209, 256, 258, 262 and 266, or according to a quantity of touched ones in the touch zones 209, 256, 258, 262 and 266.

For example, the sensing signal, which is generated when the touch zones 256 and 258 are touched, is different from the sensing signal, which is generated when the touch zones 262, 264 and 266 are touched. Various sensing signals are used for determining which preset operation should be performed, and for determining whether to perform the preset operation. Specifically, the portable communication device is unlocked when the touch zones 256 and 258 are touched, the portable communication device is waken up when the touch zones 262, 264 and 266 are touched, and the volume played by the portable communication device can be adjusted when the touch zones 256 and 262 are touched.

In this and some embodiments, according to a touched area of any one of the touch zones 209, 256, 258, 262 and 266, the portable communication device determines whether to perform the preset operation. For example, when more than a half of the touch zone 209 is touched, the portable communication device is unlocked, and when less than a half of the touch zone 209 is touched, the portable communication device is not unlocked. In this and some embodiments, the processing unit can also accumulate the touched area of the touch zones 209, 256, 258, 262 and 266, so as to determine whether to perform the preset operation.

In this and some embodiments, a quantity of the touched ones in the touch zones 209, 256, 258, 262 and 266 can also be used for determining whether to perform the preset operation.

In this and some embodiments, the processing unit can determine whether to perform the preset operation, according to a sequence which the touch zones 256, 258, 262 and 266 are touched. For example, when the touch zones 256, 258, 262 and 266 are touched in a preset sequence (e.g. a sequence from the touch zone 256 to the touch zone 264), the portable communication device is unlocked. In contrast, when the touch zones 256, 258, 262 and 266 are touched in a sequence from the touch zone 264 to the touch zone 256, the portable communication device is waken up.

In this and some embodiments, according to a time length of any touched one of the touch zones 209, 256, 258, 262 and 266, the corresponding sensing signal is generated and is used for determining whether to perform the preset operation. In an embodiment, the time length can be a time period a single touch zone, e.g. the touch zone 209, is touched. In an embodiment, the time length can be a time period a plurality of touch zones, e.g. the touch zones 209, 256, 258, 262 and 266, are touched. In an embodiment, the time length can be a time interval two of the touch zones 209, 256, 258, 262 and 266 are touched successively.

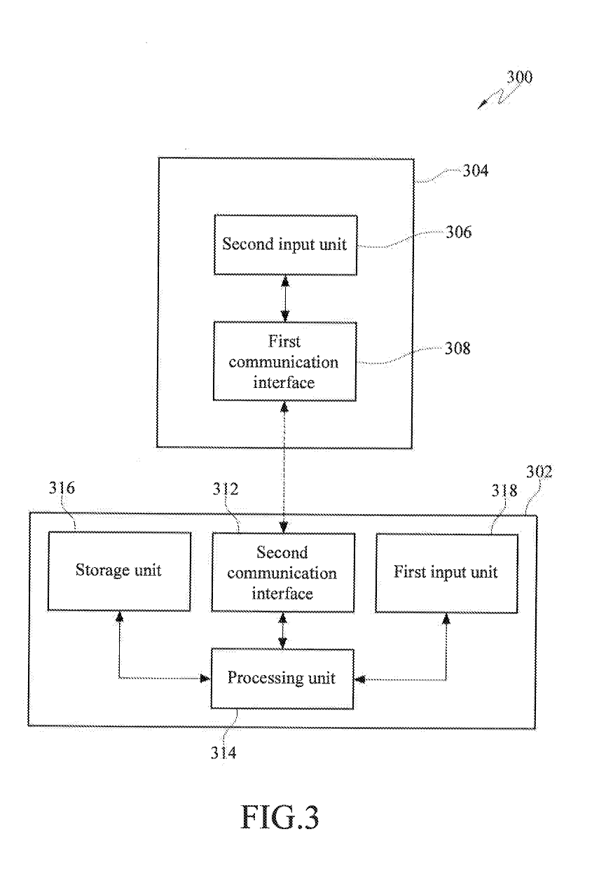

FIG. 3 is a circuit block diagram of a portable communication device 300 according to one embodiment of the disclosure. The portable communication device 300 includes a body 302 and a second casing 304. The second casing 304 includes a second input unit 306 and a first communication interface 308. The second input unit 306 is electrically connected to the body 302 through the first communication interface 308.

The body 302 includes a second communication interface 312, a processing unit 314, a storage unit 316 and a first input unit 318. The second communication interface 312 is electrically connected to the first communication interface 308. The processing unit 314 is electrically connected to the storage unit 316, the second communication interface 312 and the first input unit 318 respectively, so as to control the operation of the portable communication device 300. The operation herein includes the forgoing preset operations corresponding to the received sensing signal.

The first input unit 318 can receive the input which a user inputs, so that the processing unit 314 can control the operation of the portable communication device 300. Moreover, the first input unit 318 can serve as a display device. The second input unit 306 includes the touch zones 209, 256, 258, 262 and 266 as shown in FIG. 2A and FIG. 2B, so as to output the corresponding sensing signal after being touched. The sensing signal is transmitted to the processing unit 314 through the first communication interface 308 and the second communication interface 312. According to the received sensing signal, the processing unit 314 can determine touched states of the touch zones 209, 256, 258, 262 and 266, so that the portable communication device 300 can perform the corresponding preset operation. For example, the touched sates includes a touched area, whether the touch zone is touched or not, the sequence the touch zones are touched, the time length the touch zone is touched, and even the time interval the touch zones are touched.

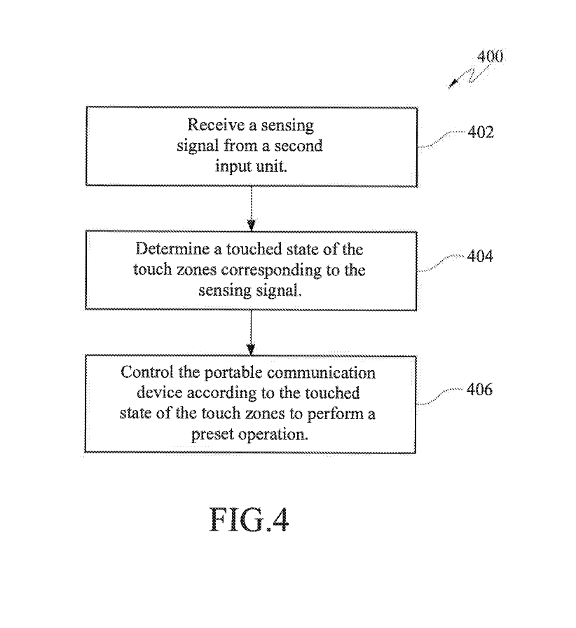

Refer to FIG. 3 and FIG. 4, the operation method 400 of the portable communication device 300 is illustrated, which includes following steps. A sensing signal generated by the second input unit, e.g. the second input unit 306, is received by the processing unit 314 (step 402). In the step 404, the processing unit 314 determines a touched state of the touch zone of the second input unit 306 corresponding to the received sensing signal. The touched states at least includes the touched area of touch zone, whether the touch zone is touched or not, the sequence of the touched touch zones, and the time length the touch zone is touched. In this and some embodiments, the determination of the touched state can be any one of the foregoing examples or a combination of some of the foregoing examples.

In the step 406, after determining the touched state of the touch zones in the second input unit 306, the processing unit controls the portable communication device to perform the preset operation. For example, when the touched area of the touch zone is grater than a first preset value, when a quantity of the touched touch zones is greater than a second preset value, when the touch zones are touched in a preset sequence, when a time length of touch zone is greater than a preset time length, when a time interval two touch zones are touched is equal to a preset requirement, or when any combination of the foregoing conditions is satisfied, the portable communication device performs the preset operation.

In the disclosure, the touch zones in the second input unit can be touched (or receive an input signal). When the touch zones are touched, a corresponding sensing signal is generated. The generated sensing signal indicates a touched state of the touch zones. When the touched state satisfies a preset condition (for example, the sequence the touch zones are touched is equal to the preset sequence), the portable communication device can perform the preset operation. Thus, the preset operation can be performed without the first input unit or any button or key on the casing (the side edge) of the portable communication device.

What is claimed is:

1. A portable communication device, comprising:
a first casing, comprising a first input unit; and
a second casing, attached to the first casing, wherein a space for placing a processing unit is defined by the second casing and the first casing;
wherein the second casing comprises a second input unit electrically connected to the processing unit, the second input unit comprises at least one touch zone, a sensing signal indicating a touched state of the touch zone is transmitted to the processing unit when the touch zone is touched, and the processing unit controls a preset operation of the portable communication device according to the sensing signal indicating the touched state of the touch zone.

2. The portable communication device according to claim 1, wherein the second casing is a back cover of the portable communication device.

3. The portable communication device according to claim 1, wherein the preset operation comprises to wake up the portable communication device and to unlock the portable communication device.

4. The portable communication device according to claim 1, wherein when a touched area of the at least one touch zone is greater than a first preset value, the portable communication device performs the corresponding preset operation.

5. The portable communication device according to claim 1, wherein the second input unit is a capacitive touch panel.

6. The portable communication device according to claim 1, wherein when a quantity of the at least one touched touch zone is greater than a second preset value, the portable communication device performs the corresponding preset operation.

7. The portable communication device according to claim 1, wherein when a sequence of the at least one touched touch zone is a preset sequence, the portable communication device performs the corresponding preset operation.

8. The portable communication device according to claim 1, wherein when a time length the at least one touch zone is touched is a preset time length, the portable communication device performs the corresponding preset operation.

9. The portable communication device according to claim 1, wherein when a time interval the touch zones are touched satisfies a preset requirement, the portable communication device performs the corresponding preset operation.

10. An operation method of a portable communication device, wherein the portable communication device comprises a first casing comprising a first input unit, and a second casing being attached to the first casing and comprising a second input unit, a space for placing a control circuit is defined by the second casing and the first casing, the control circuit is electrically connected to the second input unit, the second input unit comprises at least one touch zone, and the operation method comprises:
receiving a sensing signal from the second input unit;
determining a touched state of the at least one touch zone corresponding to the sensing signal; and
according to the touched state of the at least one touch zone, controlling the portable communication device to perform a preset operation.

11. The operation method of the portable communication device according to claim 10, further comprising:
according to the received sensing signal, determining whether a touched area of the at least one touch zone is greater than a first preset value, so as to determine whether to perform the preset operation.

12. The operation method of the portable communication device according to claim 10, wherein the preset operation comprises waking up the portable communication device and unlocking the portable communication device.

13. The operation method of the portable communication device according to claim 10, further comprising receiving an input of the first input unit.

14. The operation method of the portable communication device according to claim 10, further comprising:
according to the received sensing signal, determining whether a quantity of the at least one touch zone which is touched is greater than a second preset value, so as to determine Whether to perform the preset operation.

15. The operation method of the portable communication device according to claim 10, further comprising:
according to the received sensing signal, determining whether a sequence of the at least one touch zone which is touched is a preset sequence, so as to determine whether to perform the preset operation.

16. The operation method of the portable communication device according to claim 10, further comprising:
according to the received sensing signal, determining whether a time length the at least one touch zone is touched is a preset time length, so as to determine whether to perform the preset operation.

17. The operation method of the portable communication device according to claim 10, further comprising:
according to the received sensing signal, determining whether a time interval the touch zones are touched satisfies a preset requirement, so as to determine whether to perform the preset operation.
